(19) United States
(12) Patent Application Publication
(10) Pub. No.: US 2015/0277581 A1
(43) Pub. Date: Oct. 1, 2015

(54) MOVEMENT OF AN ELECTRONIC PERSONAL DISPLAY TO PERFORM A PAGE TURNING OPERATION

(71) Applicant: Kobo Incorporated, Toronto (CA)

(72) Inventor: Jeff COOMBS, Toronto (CA)

(73) Assignee: Kobo Incorporated, Toronto (CA)

(21) Appl. No.: 14/229,444

(22) Filed: Mar. 28, 2014

(51) Int. Cl. G06F 3/03

(52) U.S. Cl. CPC G06F 3/03

(57) ABSTRACT

A method and system for utilizing movement of an electronic personal display to perform a page turning operation is disclosed. A motion sensing device is coupled with the electronic personal display. The motion sensing device is monitored for a pre-defined movement of the electronic personal display. When the pre-defined movement is detected, a page turning operation is performed on the electronic personal display.

### BACKGROUND

An electronic reader, also known as an eReader, is a mobile electronic device that is used for reading electronic books (eBooks), electronic magazines, and other digital content. For example, the content of an eBook is displayed as words and/or images on the display of an eReader such that a user may read the content much in the same way as reading the content of a page in a paper-based book. An eReader provides a convenient format to store, transport, and view a large collection of digital content that would otherwise potentially take up a large volume of space in traditional paper format.

In some instances, eReaders are purpose built devices designed especially to perform especially well at displaying readable content. For example, a purpose built eReader may include a display that reduces glare, performs well in high light conditions, and/or mimics the look of text on actual paper. While such purpose built eReaders may excel at displaying content for a user to read, they may also perform other functions, such as displaying images, emitting audio, recording audio, and web surfing, among others.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1A shows a front perspective view of an electronic reader (eReader), in accordance with various embodiments.

FIG. 1B shows a rear perspective view of the eReader of FIG. 1A, in accordance with various embodiments.

FIG. 2 shows a cross-section of the eReader of FIG. 1A along with a detail view of a portion of the display of the eReader, in accordance with various embodiments.

FIG. 3 shows a cutaway view of an eReader illustrating one example of a touch sensor, in accordance with an embodiment.

FIG. 4 shows an example computing system which may be included as a component of an eReader, according to various embodiments.

FIG. 5 shows a block diagram of a motion sensing page turning system, according to various embodiments.

FIG. 6 illustrates a flow diagram of a method for utilizing movement of an electronic personal display to perform a page turning operation, according to various embodiments.

FIG. 7A shows a top view of a tilt or a tilt and return pre-defined movement in a left direction, according to various embodiments.

FIG. 7B shows a top view of a tilt or a tilt and return pre-defined movement in a right direction, according to various embodiments.

FIG. 8 shows a top view of a rotation or a rotation and return pre-defined movement, according to various embodiments.

FIG. 9 shows a top view of a swivel or a swivel and return pre-defined movement, according to various embodiments.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### NOTATION AND NOMENCLATURE

Unless specifically stated otherwise as apparent from the following discussions, it is appreciated that throughout the present Description of Embodiments, discussions utilizing terms such as “coupling”, “monitoring”, “detecting”, “generating”, “outputting”, “receiving”, “utilizing”, powering-up”, “powering down”, “performing” or the like, often refer to the actions and processes of an electronic computing device/system, such as an electronic reader (“eReader”), electronic personal display, and/or a mobile (i.e., handheld) multimedia device, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

### Overview of Discussion

An eReader presents digital content to a user in a page format that allows the digital content to be read by a user in a similar fashion as reading a page in a paper-based book. Thus, in an embodiment, an eReader renders the digital content in discreet pages analogous to a conventional paper book. That is, the digital page turning operation mimics physical page turning of a paper-based book. In the following discussion, a pre-defined motion of an eReader is used to perform the digital page turning operations. The pre-defined motion may be a tilt, swivel, rotation or combination thereof. The eReader includes at least one motion detection capability that can detect the pre-defined motion and then signal the eReader to perform the page turn operation. In addition, the pre-defined operation may also occur in a pre-defined time period to filter out false-page-turn actions such as a user switching hands, changing position, or the like.

The discussion will begin with description of an example eReader and various components that may be included in some embodiments of an eReader. Various display and touch sensing technologies that may be utilized with some embodiments of an eReader will then be described. An example computing system, which may be included as a component of an eReader, will then be described. Operation of an example eReader and several of its components will then be described in more detail in conjunction with a description of an example method of utilizing a non-screen capacitive touch surface for operating an electronic personal display.

### Example Electronic Reader (eReader)

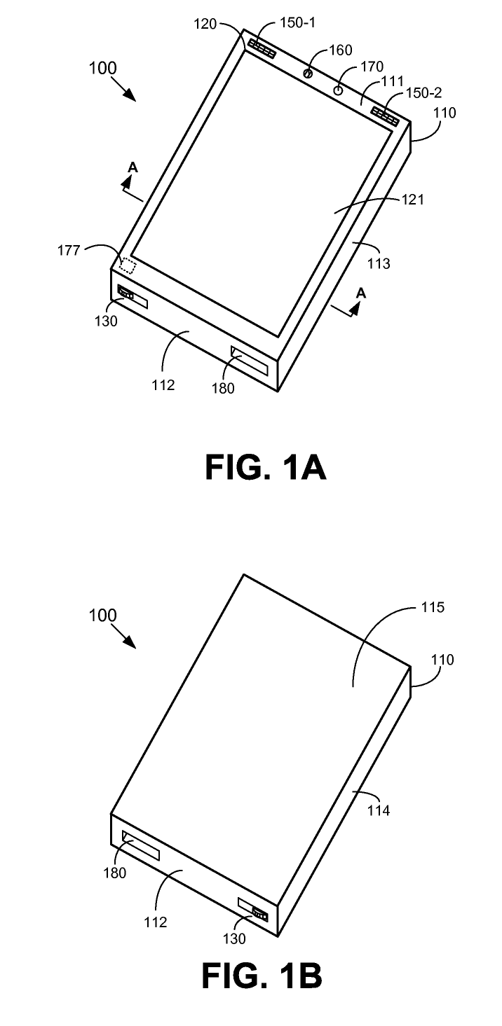

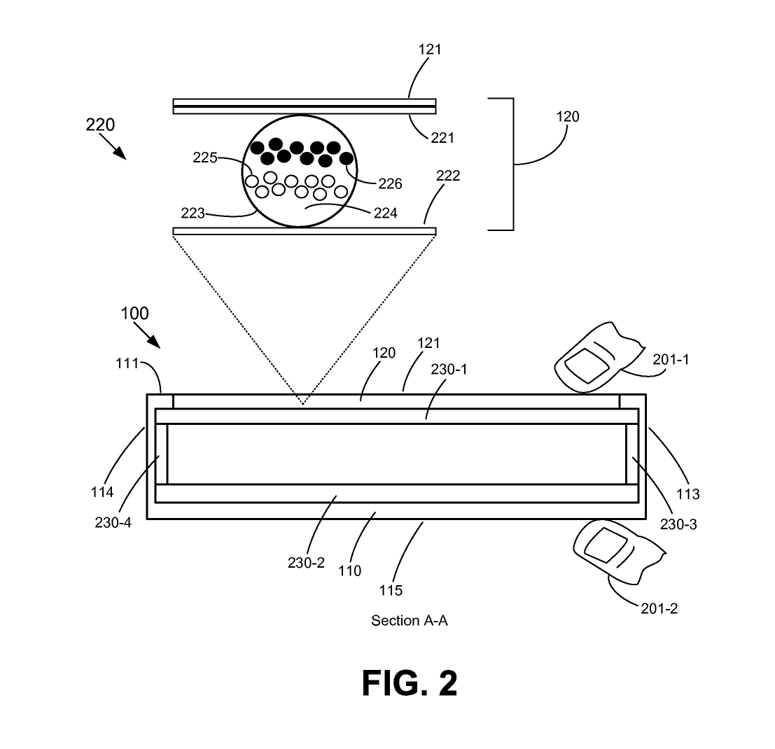

FIG. 1A shows a front perspective view of an eReader 100, in accordance with various embodiments. In general, eReader 100 is one example of an electronic personal display. Although an eReader is discussed specifically herein for purposes of example, concepts discussed are equally applicable to other types of electronic personal displays such as, but not limited to, mobile digital devices/tablet computers and/or multimedia smart phones. As depicted, eReader 100 includes a display 120, a housing 110, and some form of on/off switch 130. In some embodiments, eReader 100 may further include one or more of: speakers 150 (150-1 and 150-2 depicted), microphone 160, digital camera 170, 3D motion sensor 175, motion sensing device 177 and removable storage media slot 180. Section lines depict a region and direction of a section A-A which is shown in greater detail in FIG. 2.

Housing 110 forms an external shell in which display 120 is situated and which houses electronics and other components that are included in an embodiment of eReader 100. In FIG. 1A, a front surface 111, a bottom surface 112, and a right side surface 113 are visible. Although depicted as a single piece, housing 110 may be formed of a plurality of joined or inter-coupled portions. Housing 110 may be formed of a variety of materials such as plastics, metals, or combinations of different materials.

Display 120 has an outer surface 121 (sometimes referred to as a bezel) through which a user may view digital contents such as alphanumeric characters and/or graphic images that are displayed on display 120. Display 120 may be any one of a number of types of displays including, but not limited to: a liquid crystal display, a light emitting diode display, a plasma display, a bistable display or other display suitable for creating graphic images and alphanumeric characters recognizable to a user.

On/off switch 130 is utilized to power on/power off eReader 100. On/off switch 130 may be a slide switch (as depicted), button switch, toggle switch, touch sensitive switch, or other switch suitable for receiving user input to power on/power off eReader 100.

Speaker(s) 150, when included, operates to emit audible sounds from eReader 100. A speaker 150 may reproduce sounds from a digital file stored on or being processed by eReader 100 and/or may emit other sounds as directed by a processor of eReader 100.

Microphone 160, when included, operates to receive audible sounds from the environment proximate eReader 100. Some examples of sounds that may be received by microphone 160 include voice, music, and/or ambient noise in the area proximate eReader 100. Sounds received by microphone 160 may be recorded to a digital memory of eReader 100 and/or processed by a processor of eReader 100.

Digital camera 170, when included, operates to receive images from the environment proximate eReader 100. Some examples of images that may be received by digital camera 170 include an image of the face of a user operating eReader 100 and/or an image of the environment in the field of view of digital camera 170. Images received by digital camera 170 may be still or moving and may be recorded to a digital memory of eReader 100 and/or processed by a processor of eReader 100.

Motion sensing device 177, which monitors movement of eReader 100. Motion sensing device 177 may be a single motion sensor or a plurality of motion sensors. In one embodiment, motion sensing device 177 is selected from the group consisting of: an accelerometer, a magnetometer, a gyroscope. In an embodiment, motion sensing device 177 may be digital camera 170.

Some examples of movement that may be detected include swivel (e.g., sideways movements), tilt (e.g., up and down movements), rotation (e.g., back and forth movements) and a combination of the movements. Granularity with respect to the level of movement detected by motion sensing device 177 may be preset or user adjustable. Movements detected by motion sensing device 177 may be recorded to a digital memory of eReader 100 and/or processed by a processor of eReader 100. In one embodiment, motion sensing device 177 is fixedly coupled within the housing 110 of eReader 100. However, in another embodiment, motion sensing device 177 may be removably coupled with eReader 100 such as a wired or wireless connection.

Removable storage media slot 180, when included, operates to removably couple with and interface to an inserted item of removable storage media, such as a non-volatile memory card (e.g., MultiMediaCard (“MMC”), a secure digital (“SD”) card, or the like). Digital content for play by eReader 100 and/or instructions for eReader 100 may be stored on removable storage media inserted into removable storage media slot 180. Additionally or alternatively, eReader 100 may record or store information on removable storage media inserted into removable storage media slot 180.

FIG. 1B shows a rear perspective view of eReader 100 of FIG. 1A, in accordance with various embodiments. In FIG. 1B, a rear surface 115 of the non-display side of the housing 110 of eReader 100 is visible. Also visible in FIG. 1B is a left side surface 114 of housing 110. It is appreciated that housing 110 also includes a top surface which is not visible in either FIG. 1A or FIG. 1B.

FIG. 2 shows a cross-section A-A of eReader 100 along with a detail view 220 of a portion of display 120, in accordance with various embodiments. In addition to display 120 and housing 110, a plurality of touch sensors 230 are visible and illustrated in block diagram form. It should be appreciated that a variety of well-known touch sensing technologies may be utilized to form touch sensors 230 that are included in embodiments of eReader 100; these include, but are not limited to: resistive touch sensors; capacitive touch sensors (using self and/or mutual capacitance); inductive touch sensors; and infrared touch sensors. In general, resistive touch sensing responds to pressure applied to a touched surface and is implemented using a patterned sensor design on, within, or beneath display 120, rear surface 115, and/or other surface of housing 110. In general, inductive touch sensing requires the use of a stylus and are implemented with a patterned electrode array disposed on, within, or beneath display 120, rear surface 115, and/or other surface of housing 110 In general, capacitive touch sensing utilizes a patterned electrode array disposed on, within, or beneath display 120, rear surface 115, and/or other surface of housing 110; and the patterned electrodes sense changes in capacitance caused by the proximity or contact by an input object. In general, infrared touch sensing operates to sense an input object breaking one or more infrared beams that are projected over a surface such as outer surface 121, rear surface 115, and/or other surface of housing 110.

Once an input object interaction is detected by a touch sensor 230, it is interpreted either by a special purpose processor (e.g., an application specific integrated circuit (ASIC)) that is coupled with the touch sensor 230 and the interpretation is passed to a processor of eReader 100, or a processor of eReader is used to directly operate and/or interpret input object interactions received from a touch sensor 230. It should be appreciated that in some embodiments, patterned sensors and/or electrodes may be formed of optically transparent material such as very thin wires or a material such as indium tin oxide (ITO).

In various embodiments one or more touch sensors 230 (230-1 front; 230-2 rear; 230-3 right side; and/or 230-4 left side) may be included in eReader 100 in order to receive user input from input object 201 such as styli or human digits. For example, in response to proximity or touch contact with outer surface 121 or coversheet (not illustrated) disposed above outer surface 121, user input from one or more fingers such as finger 201-1 may be detected by touch sensor 230-1 and interpreted. Such user input may be used to interact with graphical content displayed on display 120 and/or to provide other input through various gestures (e.g., tapping, swiping, pinching digits together on outer surface 121, spreading digits apart on outer surface 121, or other gestures).

In a similar manner, in some embodiments, a touch sensor 230-2 may be disposed proximate rear surface 115 of housing 110 in order to receive user input from one or more input objects 201, such as human digit 201-2. In this manner, user input may be received across all or a portion of the rear surface 115 in response to proximity or touch contact with rear surface 115 by one or more user input objects 201. In some embodiments, where both front (230-1) and rear (230-2) touch sensors are included, a user input may be received and interpreted from a combination of input object interactions with both the front and rear touch sensors.

In a similar manner, in some embodiments, a left side touch sensor 230-3 and/or a right side touch sensor 230-4, when included, may be disposed proximate the respective left and/or right side surfaces (113, 114) of housing 110 in order to receive user input from one or more input objects 201. In this manner, user input may be received across all or a portion of the left side surface 113 and/or all or a portion of the right side surface 114 of housing 110 in response to proximity or touch contact with the respective surfaces by or more user input objects 201. In some embodiments, instead of utilizing a separate touch sensor, a left side touch sensor 230-3 and/or a right side touch sensor 230-4 may be a continuation of a front touch sensor 230-1 or a rear touch sensor 230-2 which is extended so as to facilitate receipt proximity/touch user input from one or more sides of housing 110.

Although not depicted, in some embodiments, one or more touch sensors 230 may be similarly included and situated in order to facilitate receipt of user input from proximity or touch contact by one or more user input objects 201 with one or more portions of the bottom 112 and/or top surfaces of housing 110.

Referring still to FIG. 2, a detail view 220 is show of display 120, according to some embodiments. Detail 220 depicts a portion of a bistable electronic ink that is used, in some embodiments, when display 120 is a bistable display. In some embodiments, a bistable display is utilized in eReader 100 as it presents a paper and ink like image and/or because it is a reflective display rather than an emissive display and thus can present a persistent image on display 120 even when power is not supplied to display 120. In one embodiment, a bistable display comprises electronic ink the form of millions of tiny optically clear capsules 223 that are filled with an optically clear fluid 224 in which positively charged white pigment particles 225 and negatively charged black pigment particles 226 are suspended. The capsules 223 are disposed between bottom electrode 222 and a transparent top electrode 221. A transparent/optically clear protective surface is often disposed over the top of top electrode 221 and, when included, this additional transparent surface forms outer surface 121 of display 120 and forms a touch surface for receiving touch inputs. It should be appreciated that one or more intervening transparent/optically clear layers may be disposed between top electrode 221 and top electrode 221. In some embodiments, one or more of these intervening layers may include a patterned sensor and/or electrodes for touch sensor 230-1. When a positive or negative electric field is applied proximate to each of bottom electrode 222 and top electrode 221 in regions proximate capsule 223, pigment particles of opposite polarity to a field are attracted to the field, while pigment particles of similar polarity to the applied field are repelled from the field. Thus, when a positive charge is applied to top electrode 221 and a negative charge is applied to bottom electrode 221, black pigment particles 226 rise to the top of capsule 223 and white pigment particles 225 go to the bottom of capsule 223. This makes outer surface 121 appear black at the point above capsule 223 on outer surface 121. Conversely, when a negative charge is applied to top electrode 221 and a positive charge is applied to bottom electrode 221, white pigment particles 225 rise to the top of capsule 223 and black pigment particles 226 go to the bottom of capsule 223. This makes outer surface 121 appear white at the point above capsule 223 on outer surface 121. It should be appreciated that variations of this technique can be employed with more than two colors of pigment particles.

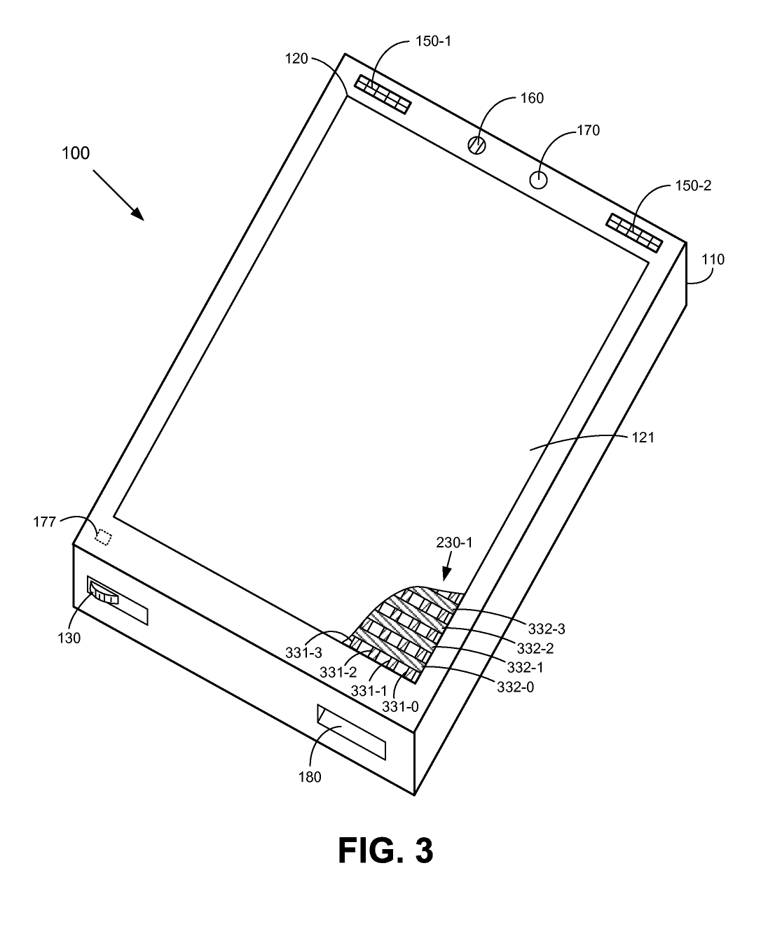

FIG. 3 shows a cutaway view of an eReader illustrating one example of a touch sensor 230, in accordance with an embodiment. In FIG. 3, a portion of display 120 has been removed such that a portion of underlying top sensor 230-1 is visible. As depicted, in one embodiment, top touch sensor 230-1 is illustrated as an x-y grid of sensor electrodes which may be used to perform various techniques of capacitive sensing. For example, sensor electrodes 331 (331-0, 331-1, 331-2, and 331-3 visible) are arrayed along a first axis, while sensor electrodes 332 (332-0, 332-1, 332-2, and 332-3 visible) are arrayed along a second axis that is approximately perpendicular to the first axis. It should be appreciated that a dielectric layer (not illustrated) is disposed between all or portions of sensor electrodes 331 and 332 to prevent shorting. It should also be appreciated that the pattern of sensor electrodes (331, 332) illustrated in FIG. 3 has been provided an example only, that a variety of other patterns may be similarly utilized, and some of these patterns may only utilize sensor electrodes disposed in a single layer. Additionally, while the example of FIG. 3 illustrates top sensor 230-1 as being disposed beneath display 120, in other embodiments, portions of touch sensor 230-1 may be transparent and disposed either above display 120 or integrated with display 120.

In one embodiment, by performing absolute/self-capacitive sensing with sensor electrodes 331 on the first axis a first profile of any input object contacting outer surface 121 can be formed, and then a second profile of any input object contacting outer surface 121 can be formed on an orthogonal axis by performing absolute/self-capacitive sensing on sensor electrodes 332. These capacitive profiles can be processed to determine an occurrence and/or location of a user input with made by means of an input object 201 contacting or proximate outer surface 121.

In another embodiment, by performing transcapacitive/mutual capacitive sensing between sensor electrodes 331 on the first axis and sensor electrodes 332 on the second axis a capacitive image can be formed of any input object contacting outer surface 121. This capacitive image can be processed to determine occurrence and/or location of user input made by means of an input object contacting or proximate outer surface 121.

It should be appreciated that mutual capacitive sensing is regarded as a better technique for detecting multiple simultaneous input objects in contact with a surface such as outer surface 121, while absolute capacitive sensing is regarded as a better technique for proximity sensing of objects which are near but not necessarily in contact with a surface such as outer surface 121.

In some embodiments, capacitive sensing and/or another touch sensing technique may be used to sense touch input across all or a portion of the rear surface 115 of eReader 100, and/or any other surface(s) of housing 110.

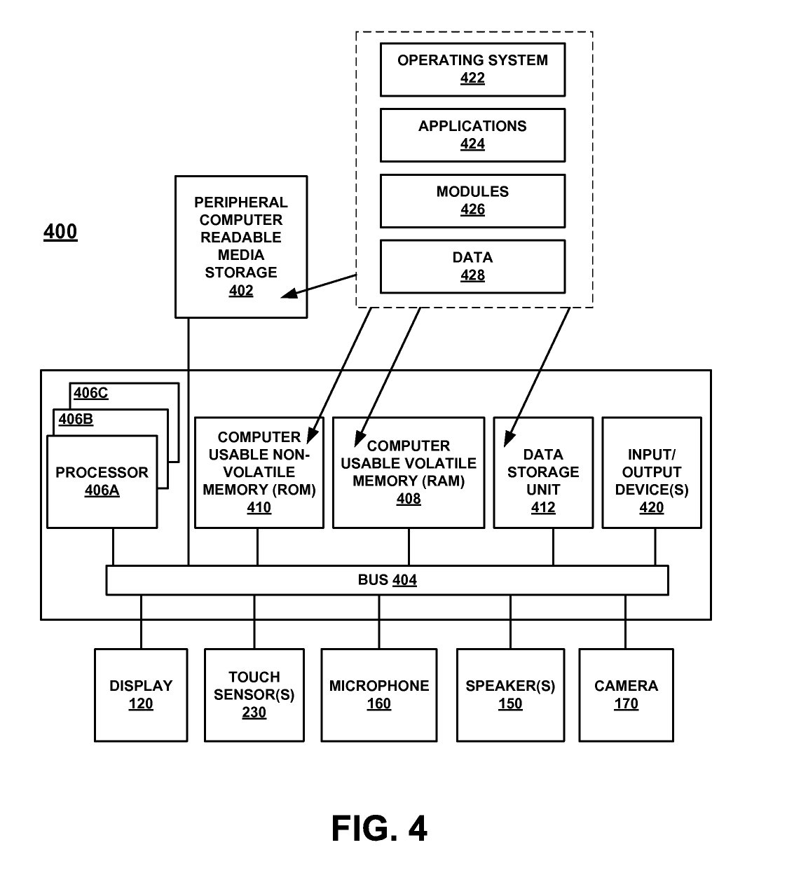

FIG. 4 shows an example computing system 400 which may be included as a component of an eReader, according to various embodiments and with which or upon which various embodiments described herein may operate.

### Example Computer System Environment

With reference now to FIG. 4, all or portions of some embodiments described herein are composed of computer-readable and computer-executable instructions that reside, for example, in computer-usable/computer-readable storage media of a computer system. That is, FIG. 4 illustrates one example of a type of computer (computer system 400) that can be used in accordance with or to implement various embodiments of an eReader, such as eReader 100, which are discussed herein. It is appreciated that computer system 400 of FIG. 4 is only an example and that embodiments as described herein can operate on or within a number of different computer systems.

System 400 of FIG. 4 includes an address/data bus 404 for communicating information, and a processor 406A coupled to bus 404 for processing information and instructions. As depicted in FIG. 4, system 400 is also well suited to a multi-processor environment in which a plurality of processors 406A, 406B, and 406C are present. Processors 406A, 406B, and 406C may be any of various types of microprocessors. For example, in some multi-processor embodiments, one of the multiple processors may be a touch sensing processor and/or one of the processors may be a display processor. Conversely, system 400 is also well suited to having a single processor such as, for example, processor 406A. System 400 also includes data storage features such as a computer usable volatile memory 408, e.g., random access memory (RAM), coupled to bus 404 for storing information and instructions for processors 406A, 406B, and 406C. System 400 also includes computer usable non-volatile memory 410, e.g., read only memory (ROM), coupled to bus 404 for storing static information and instructions for processors 406A, 406B, and 406C. Also present in system 400 is a data storage unit 412 (e.g., a magnetic or optical disk and disk drive) coupled to bus 404 for storing information and instructions.

Computer system 400 of FIG. 4 is well adapted to having peripheral computer-readable storage media 402 such as, for example, a floppy disk, a compact disc, digital versatile disc, universal serial bus “flash” drive, removable memory card, and the like coupled thereto. In some embodiments, computer-readable storage media 402 may be coupled with computer system 400 (e.g., to bus 404) by insertion into removable a storage media slot, such as removable storage media slot 180 depicted in FIGS. 1A and 1B.

System 400 also includes or couples with display 120 for visibly displaying information such as alphanumeric text and graphic images. In some embodiments, system 400 also includes or couples with one or more optional sensors 430 for communicating information, cursor control, gesture input, command selection, and/or other user input to processor 406A or one or more of the processors in a multi-processor embodiment. In general, optional sensors 420 may include, but is not limited to, touch sensor 230, 3D motion sensor 175, motion sensing device 177 and the like. In some embodiments, system 400 also includes or couples with one or more optional speakers 150 for emitting audio output. In some embodiments, system 400 also includes or couples with an optional microphone 160 for receiving/capturing audio inputs. In some embodiments, system 400 also includes or couples with an optional digital camera 170 for receiving/capturing digital images as an input.

Optional sensor(s) 430 allows a user of computer system 400 (e.g., a user of an eReader of which computer system 400 is a part) to dynamically signal the movement of a visible symbol (cursor) on display 120 and indicate user selections of selectable items displayed on display 120. In some embodiment other implementations of a cursor control device and/or user input device may also be included to provide input to computer system 400, a variety of these are well known and include: trackballs, keypads, directional keys, and the like. System 400 is also well suited to having a cursor directed or user input received by other means such as, for example, voice commands received via microphone 160. System 400 also includes an input/output (I/O) device 420 for coupling system 400 with external entities. For example, in one embodiment, I/O device 420 is a modem for enabling wired communications or modem and radio for enabling wireless communications between system 400 and an external device and/or external network such as, but not limited to, the Internet. I/O device 120 may include a short-range wireless radio such as a Bluetooth® radio, Wi-Fi radio (e.g., a radio compliant with Institute of Electrical and Electronics Engineers' (IEEE) 802.11 standards), or the like.

Referring still to FIG. 4, various other components are depicted for system 400. Specifically, when present, an operating system 422, applications 424, modules 426, and/or data 428 are shown as typically residing in one or some combination of computer usable volatile memory 408 (e.g., RAM), computer usable non-volatile memory 410 (e.g., ROM), and data storage unit 412. In some embodiments, all or portions of various embodiments described herein are stored, for example, as an application 424 and/or module 426 in memory locations within RAM 408, ROM 410, computer-readable storage media within data storage unit 412, peripheral computer-readable storage media 402, and/or other tangible computer readable storage media.

### Operation

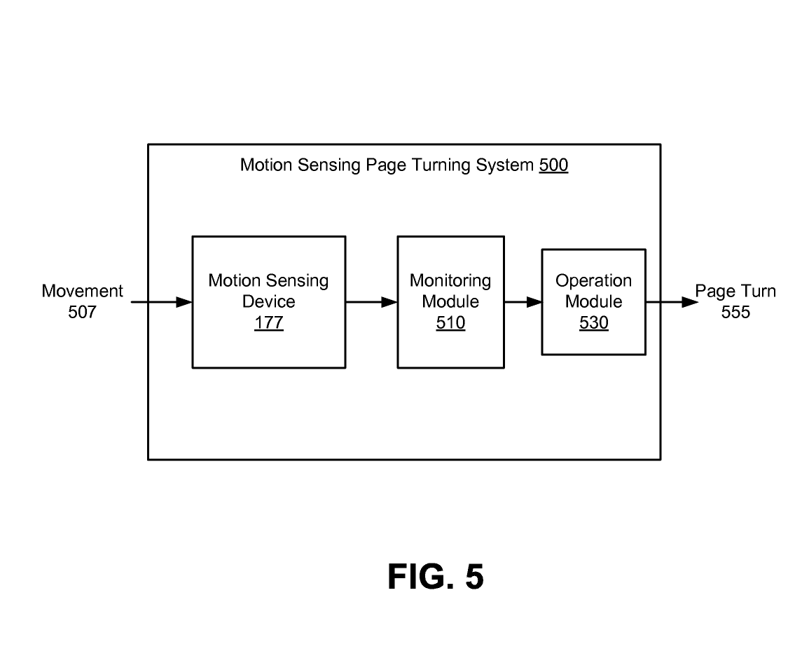

With reference now to FIG. 5, a block diagram of a motion sensing page turning system 500 for performing a page turning operation on an electronic personal display is shown in accordance with an embodiment. One example of an electronic personal display is an electronic reader (eReader).

In one embodiment, motion sensing page turning system 500 includes a sensing device 177, monitoring module 510, and an operation module 530 that provides a page turn operation 555. Although the components are shown as distinct objects in the present discussion, it is appreciated that the operations of one or more of the components may be combined into a single module. Moreover, it is also appreciated that the actions performed by a single module described herein could also be broken up into actions performed by a number of different modules or performed by a different module altogether. The present breakdown of assigned actions and distinct modules are merely provided herein for purposes of clarity.

Motion sensing device 177 is a motion recognition sensor or group of sensors that may include one or more of: an accelerometer, a gyroscope, a camera 170, a magnetometer and the like. In general, motion sensing device 177 recognizes movement 507 related to the electronic personal display.

In one embodiment, monitoring module 510 monitors output from motion sensing device 177. For example, when movement 507 is detected a signal is output from motion sensing device 177. For example, when a movement 507 of the eReader occurs, a signal is output from motion sensing device 177 regarding the type of movement that was observed.

Monitoring module 510 receives the motion detected output from motion sensing device 177 and correlates the motion detected with a pre-defined movement indicating a page turn operation. If the detected motion matches the pre-defined movement, monitoring module 510 will pass the information to operation module 530. Operation module 530 will then cause the page turn 555 to occur. In one embodiment, the pre-defined movement indicates a page forward operation. In another embodiment, the pre-defined movement indicates a page back operation

In general, the pre-defined movement of the electronic display may be factory set, user adjustable, user selectable, or the like. In one embodiment, if movement 507 is not an exact match to a pre-defined gesture, but is a proximate match for the operation, the correlation settings could be widened such that a gesture with a medium correlation is recognized. In another embodiment, the correlation settings could be narrowed such that only movement 507 with a high correlation to the pre-defined movement will be recognized.

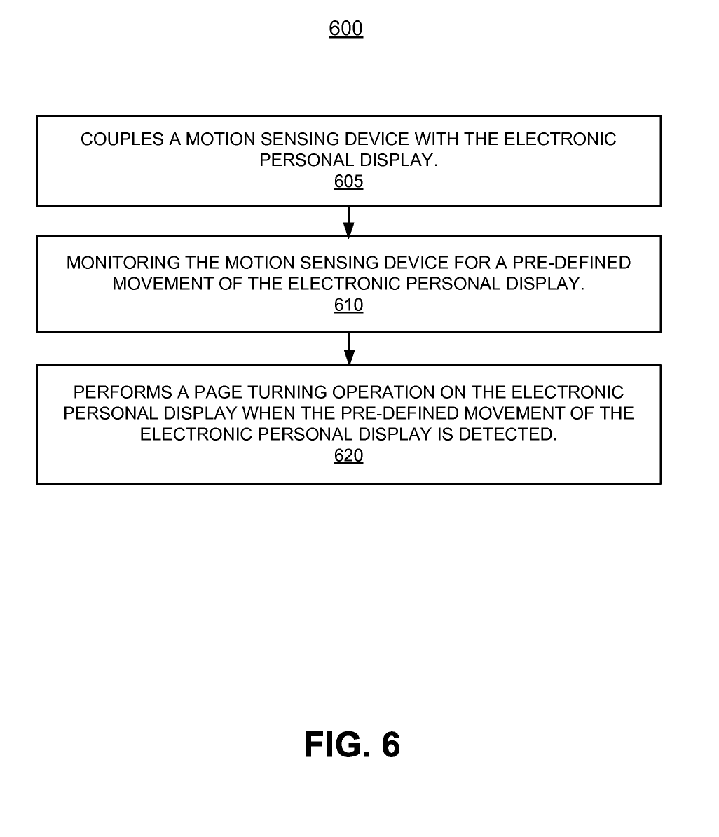

FIG. 6 illustrates a flow diagram 600 of a method for utilizing movement of an electronic personal display to perform a page turning operation. In one embodiment, the electronic personal display is an electronic reader (eReader).

Referring now to 605 of FIG. 6, one embodiment couples a motion sensing device 177 with the electronic personal display. In general, the motion sensing device 177 may be selected from one or more of a number of gesture recognition sensors, such as but not limited to, an accelerometer, a magnetometer, a gyroscope and a camera.

In operation, when an accelerometer experiences acceleration, a mass is displaced to the point that a spring is able to accelerate the mass at the same rate as the casing. The displacement is then measured thereby determining the acceleration. In one embodiment, piezoelectric, piezoresistive and capacitive components are used to convert the mechanical motion into an electrical signal. For example, piezoelectric accelerometers are useful for upper frequency and high temperature ranges. In contrast, piezoresistive accelerometers are valuable in higher shock applications. Capacitive accelerometers use a silicon micro-machined sensing element and perform well in low frequency ranges. In another embodiment, the accelerometer may be a micro electro-mechanical systems (MEMS) consisting of a cantilever beam with a seismic mass.

A magnetometer, such as a magnetoresistive permalloy sensor can be used as a compass. For example, using a three-axis magnetometer allows a detection of a change in direction regardless of the way the device is oriented. That is, the three-axis magnetometer is not sensitive to the way it is oriented as it will provide a compass type heading regardless of the device's orientation.

In general, a gyroscope measures or maintains orientation based on the principles of angular momentum. In one embodiment, the combination of a gyroscope and an accelerometer within motion sensing device 177 to provide more robust direction and motion sensing.

A camera can be used to provide egomotion, e.g., recognition of the 3D motion of the camera based on changes in the images captured by the camera. In one embodiment, the process of estimating a camera's motion within an environment involves the use of visual odometry techniques on a sequence of images captured by the moving camera. In one embodiment, it is done using feature detection to construct an optical flow from two image frames in a sequence. For example, features are detected in the first frame, and then matched in the second frame. The information is then used to make the optical flow field showing features diverging from a single point, e.g., the focus of expansion. The focus of expansion indicates the direction of the motion of the camera. Other methods of extracting egomotion information from images, method that avoid feature detection and optical flow fields are also contemplated. Such methods include using the image intensities for comparison and the like.

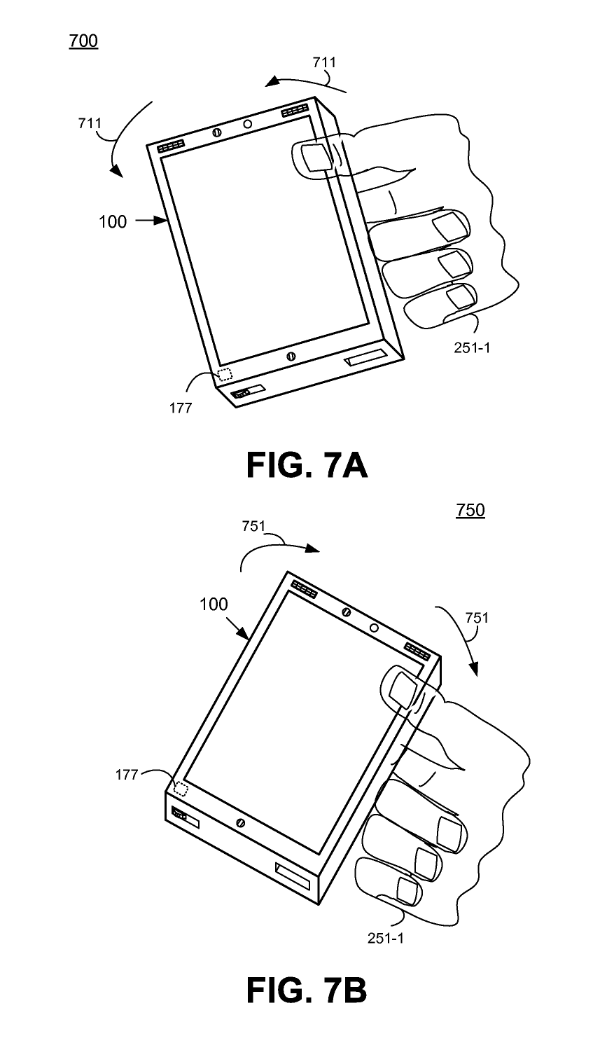

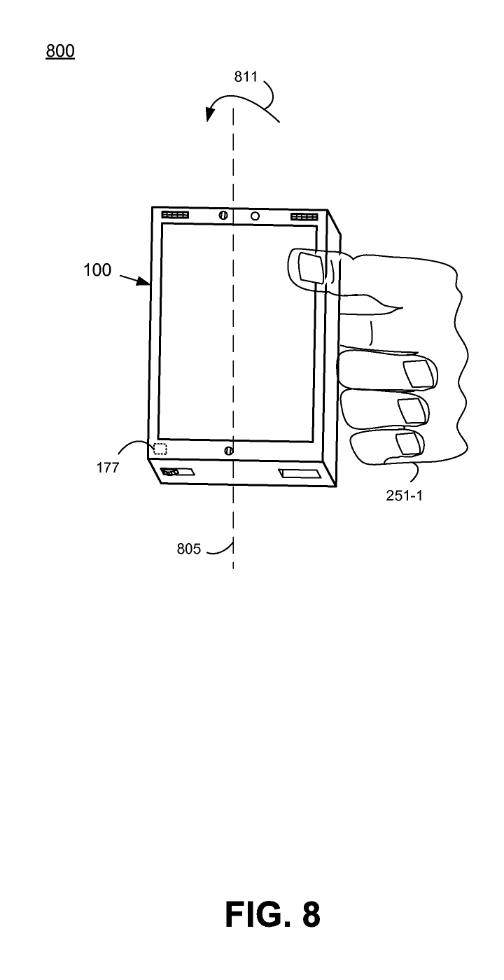

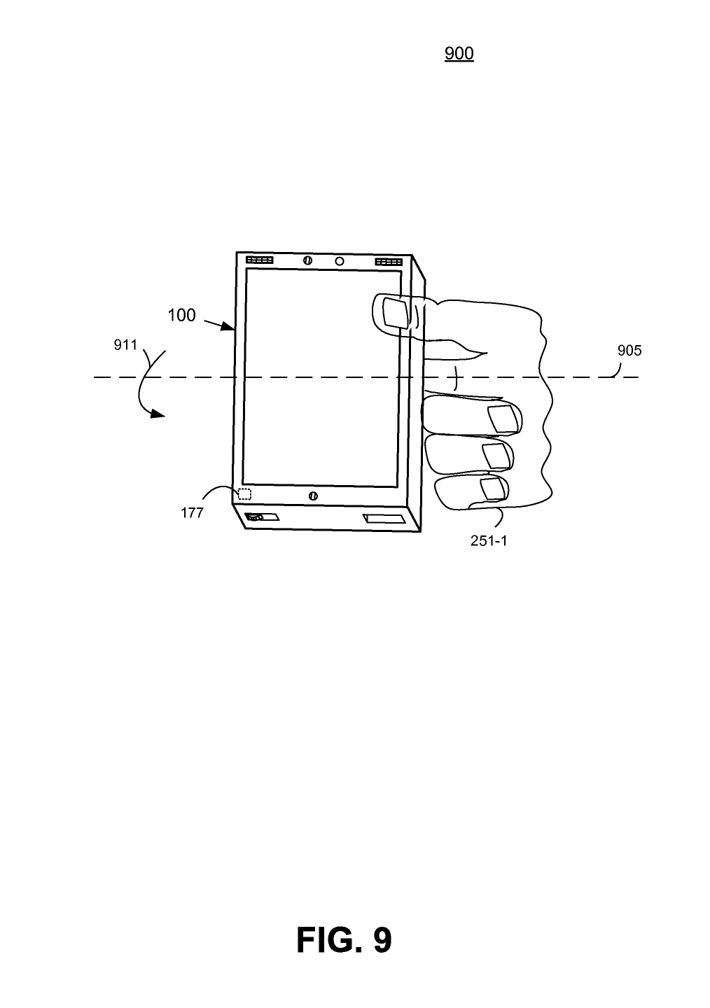

Referring now to 610 of FIGS. 6 and 7A-9, one embodiment monitors motion sensing device 177 for a pre-defined movement of the electronic personal display. For example, the pre-defined movement may consist of: a tilt or a tilt and return as shown in FIGS. 7A and 7B, a swivel or a swivel and return as shown in FIG. 9, a rotation or a rotation and return as shown in FIG. 8. Although a number of types of movement 507 that may be correlated to a pre-defined movement are shown in FIGS. 7A-9, there may be different or additional pre-defined movements including a combination of movements. In one embodiment, the pre-defined movement is expandable by a user's individual preferences. That is, the user may expand the pre-defined movement by developing individualized pre-defined movements. For example, one user may define a page forward operation as a tilt and return type motion while another user may define a page forward operation as a rotate type motion.

With reference now to FIGS. 7A-7B a tilt or a tilt and return pre-defined movement is shown. In 700 of FIG. 7A, eReader 100 is shown with motion sensing device 177 being held by hand 251-1. In diagram 700, the pre-defined movement is a tilt to the left as indicated by arrows 711. In one embodiment, the tilt to the left, or the tilt to the left and return to the center is indicative of a page forward operation. In diagram 750 of FIG. 7B, the pre-defined movement is a tilt to the right as indicated by arrows 751. In one embodiment, the tilt to the right, or the tilt to the right and return to the center is indicative of a page back command. Although the tilt to the right is stated as a page back command and the tilt to the left is stated as a page forward command, in FIG. 7A-9, it should be appreciated that the directions and subsequent commands can be reversed. For example, a tilt to the left, or to the left and then return may indicate a page back command.

Referring now to FIG. 8, in diagram 800 a rotation or a rotation and return pre-defined movement is shown. In diagram 800, eReader 100 is rotated about a vertical axis 805. For example, in one embodiment, as indicated by arrow 811 eReader 100 is rotated to the left or to the left and back to center to indicate a page forward operation. Similarly, if eReader 100 is rotated to the right or to the right and back to center (counter arrow 811) a page back command is recognized. Again, it should be appreciated that the directions and subsequent commands associated with the direction can be reversed.

In FIG. 9, diagram 900 illustrates a swivel or a swivel and return pre-defined movement. In diagram 900, eReader 100 is swiveled about a horizontal axis 905. For example, in one embodiment, as indicated by arrow 911 eReader 100 is swiveled toward a user or toward the user and then back to center to indicate a page forward operation. Similarly, if eReader 100 is swiveled away from the user or away from the user and back to center (counter arrow 911) a page back command is recognized. Again, it should be appreciated that the directions and subsequent commands associated with the direction can be reversed.

In addition to a pre-defined movement, movement 507 must also occur within a pre-set time period, such as within a portion of a second, a few seconds or the like. In addition, the pre-set time period may be user adjustable. For example, a pre-set time period for the pre-defined movement would filter out or minimize potential triggering of “false-page-turn” signals; such as when the user switches hands for reading, puts down the device, or the like. In one embodiment, the pre-defined movement may be performed with a single hand while within the reading application or reading experience. In another embodiment, the pre-defined movement may be performed with both hands.

Referring now to 620 of FIG. 6, one embodiment performs a page turning operation on the electronic personal display when the pre-defined movement of the electronic personal display is detected. That is, if the detected motion matches the pre-defined movement, a page turn 555 will occur. As stated herein, the pre-defined movement of the electronic display may be factory set, user adjustable, user selectable, or the like. In one embodiment, if movement 507 is not an exact match to a pre-defined gesture, but is a proximate match for the operation, the correlation settings could be widened such that a gesture with a medium correlation is recognized. In another embodiment, the correlation settings could be narrowed such that only movement 507 with a high correlation to the pre-defined movement will be recognized.

In one embodiment, if movement 507 has no associated pre-defined movement but movement 507 is performed a number of times within a certain time period, a help menu may pop up in an attempt to ascertain the user's intention. In one embodiment, the menu may provide insight to allow the user to find the proper pre-defined movement for the desired action.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A method for utilizing movement of an electronic personal display to perform a page turning operation, said method comprising:
coupling a motion sensing device with the electronic personal display;
monitoring the motion sensing device for a pre-defined movement of the electronic personal display; and
performing a page turning operation on the electronic personal display when the pre-defined movement of the electronic personal display is detected.

2. The method of claim 1 wherein the electronic personal display is an electronic reader (eReader).

3. The method of claim 1 further comprising:
defining a tilting movement of the electronic display as the pre-defined movement of the electronic personal display.

4. The method of claim 1 further comprising:
defining a swivel movement of the electronic display as the pre-defined movement of the electronic personal display.

5. The method of claim 1 further comprising:
defining a rotating movement of the electronic display as the pre-defined movement of the electronic personal display.

6. The method of claim 1 further comprising:
utilizing an accelerometer coupled with the electronic personal display to detect the pre-defined movement of the electronic personal display.

7. The method of claim 1 further comprising:
utilizing a magnetometer coupled with the electronic personal display to detect the pre-defined movement of the electronic personal display.

8. The method of claim 1 further comprising:
utilizing a gyroscope coupled with the electronic personal display to detect the pre-defined movement of the electronic personal display.

9. The method of claim 1 further comprising:
utilizing a camera coupled with the electronic personal display to detect the pre-defined movement of the electronic personal display.

10. An electronic personal display with motion sensing for page turning comprising:
a motion sensing device coupled with the electronic personal display;
a monitoring module to monitor an output from the motion sensing device and provide a page turn command when a pre-defined motion is detected by the motion sensing device; and
an operation module to receive the output from the monitoring module and perform a page turn action related to the output.

11. The electronic personal display of claim 10 wherein the motion sensing device comprises a single motion sensor type selected from the group consisting of: an accelerometer, a magnetometer, a gyroscope and a camera.

12. The electronic personal display of claim 10 wherein the motion sensing device comprises at least two different motion sensor types selected from the group consisting of: an accelerometer, a magnetometer, a gyroscope and a camera.

13. The electronic personal display of claim 10 wherein the motion sensing device comprises at least three motion sensor types selected from the group consisting of: an accelerometer, a magnetometer, a gyroscope and a camera.

14. The electronic personal display of claim 10 wherein the pre-defined motion comprises at least one motion selected from the group consisting of: a tilt, a tilt and return, a swivel, a swivel and return, a rotation and a rotation and return.

15. The electronic personal display of claim 10 wherein the pre-defined motion comprises:
a pre-set time period within which the pre-defined motion is to be performed.

16. A method for utilizing pre-defined movement of an electronic reader (eReader) to perform a page turning operation, said method comprising:
coupling a motion sensing device with the eReader;
monitoring the motion sensing device for a pre-defined movement of the eReader; and
performing a page turning operation on the eReader when the pre-defined movement is detected; wherein a pre-defined movement in a first direction invokes a page forward action and a pre-defined movement in a direction opposite of the first direction invokes a page back action.

17. The method of claim 16 wherein the motion sensing device comprises a single motion sensor type selected from the group consisting of: an accelerometer, a magnetometer, a gyroscope and a camera.

18. The method of claim 16 wherein the motion sensing device comprises at least two different motion sensor types selected from the group consisting of: an accelerometer, a magnetometer, a gyroscope and a camera.

19. The method of claim 16 wherein the motion sensing device comprises at least three motion sensor types selected from the group consisting of: an accelerometer, a magnetometer, a gyroscope and a camera.

20. The method of claim 16 wherein the pre-defined movement comprises at least one movement selected from the group consisting of: a tilt, a tilt and return, a swivel, a swivel and return, a rotation and a rotation and return.

21. The method of claim 16 further comprising:
providing a pre-set time period within which the pre-defined movement is to be performed.
